(19) United States
(12) Patent Application Publication
(10) Pub. No.: US 2024/0200785 A1
(43) Pub. Date: Jun. 20, 2024

(54) MICROWAVE OVEN THAT RECOGNIZES POSITION OF FOOD ITEM WITHIN CAVITY FOR COOKING AND METHOD OF OPERATING THE SAME

(71) Applicant: WHIRLPOOL CORPORATION, BENTON HARBOR, MI (US)

(72) Inventors: Abdalla Elabd, Leamington Spa (GB); Jean Ricardo Rusczak, Kalamazoo, MI (US)

(73) Assignee: WHIRLPOOL CORPORATION, BENTON HARBOR, MI (US)

(21) Appl. No.: 18/517,702

(22) Filed: Nov. 22, 2023

Related U.S. Application Data
(60) Provisional application No. 63/433,835, filed on Dec. 20, 2022.

(51) Int. Cl. F24C 7/08; F24C 7/02; H05B 6/64; H05B 6/68

(52) U.S. Cl. CPC F24C 7/087; F24C 7/02; H05B 6/6455; H05B 6/687

(57) ABSTRACT

A microwave oven includes a controller in communication with an infrared sensor and a human-machine interface, the controller configured: (i) to determine a temperature at each position of a cavity as a function of the output of each pixel of the infrared sensor; (ii) to recognize a rise and fall in the temperature at one or more positions within the cavity; (iii) to estimate the position or positions within the cavity that a food item occupies as a function of the one or more positions within the cavity where the controller recognized the rise and fall in temperature occurred; and (iv) to determine whether the position or positions that the food item is estimated to occupy is adequate for the controller to determine accurately a temperature of the food item during an automatic heating operation that utilizes the infrared sensor.

### CROSS-REFERENCE TO RELATED APPLICATION

This application claims the benefit of U.S. Provisional Patent Application No. 63/433,835, filed 20 Dec. 2022, the entire contents of which are incorporated herein by reference.

### BACKGROUND OF THE DISCLOSURE

The present disclosure generally relates to a microwave oven, and more specifically, to a microwave oven that determines the position of a food item placed therein for an automatic heating operation before the automatic heating operation commences.

A microwave oven is a kitchen appliance that uses electromagnetic radiation to heat a food item placed within a cavity thereof. For example, a magnetron within the microwave oven can emit microwaves into the cavity. Water molecules of the food item within the microwave oven absorb the microwaves, which causes the water molecules to vibrate and generate heat. The generated heat conducts through the food item.

Some microwave ovens include an automatic heating function. With the automatic heating function, an infrared sensor of the microwave oven is utilized to determine a temperature of the food item being heated. In general, when the determined temperature of the food item reaches a desired temperature, the microwave oven ceases emitting microwaves.

Accuracy of the determination of the temperature of the food item is a function of position of the food relative to the infrared sensor. In short, the further the food item is from the infrared sensor, the less accurate the determination of the temperature of the food item from the output of the infrared sensor will be. A lack of uniform microwave energy distribution throughout a cavity in which the food item is placed for heating compounds the inaccuracy of the temperature determination.

### SUMMARY OF THE DISCLOSURE

When the food item is at a temperature sufficiently different than the cavity of the microwave, the infrared sensor can be utilized to identify the position of the food item relative to the infrared sensor. Such instances include when the food item is frozen, or when the food item is warm but not as warm as desired, while the cavity is near room temperature. The temperature of the food item and the temperature of the cavity sufficiently contrast for the microwave oven to determine the position of the food item relative to the infrared sensor, before the heating operation begins. If the food item is determined to be too far from the infrared sensor for the microwave oven to determine accurately the temperature of the food item during the heating operation, then the microwave oven can prompt the user to reposition the food item to a position closer to the infrared sensor.

However, there is a problem in that, when the temperature of the food item and the temperature of the cavity are approximately the same, the microwave oven cannot utilize a contrast in the temperatures (as determined via output from the infrared sensor) to determine the position of the food item before the heating operation begins. The microwave oven would then first have to heat the food item to generate the temperature contrast with the cavity and then determine whether the food item had been properly placed within the cavity relative to the infrared sensor to allow for accurate automatic heating of the food item. If the microwave oven determines that the food item is inadequately placed within the cavity, then the microwave would have to stop the heating operation, notify the user, and wait for the user to replace the food item at a better position within the cavity. That may cause the user to be less than completely satisfied.

The present disclosure addresses that problem by (i) estimating where in the cavity of the microwave oven the user has placed the food item relative to an infrared sensor of the microwave oven, despite the temperature of the food item not contrasting with the temperature of the cavity, (ii) determining whether the food item is placed in a position within the cavity that allows the infrared sensor to provide output that is accurate enough to determine a temperature of the food item, and (iii) if it is determined that the user has not placed the food item in such a position, then notifying the user to replace the food item in such a position. As will be further elaborated upon herein, the microwave oven can estimate where in the cavity the user has placed the food item by recognizing, via output from the infrared sensor, a rise and fall in temperature at one or more positions within the cavity. The rise and fall in temperature is indicative of a hand of the user entering the cavity to place the food item therein and, then, leaving the cavity. Although the food item and the cavity may be at similar temperatures, the hand of the user is likely at a much higher temperature than the cavity. Thus, the output of the infrared sensor can be interpreted to determine the presence of the hand in the cavity and the assumed deposit of the food item within the cavity. The output of the infrared sensor can further be utilized to determine the positions of the hand within the cavity while the hand was delivering the food item into the cavity. From the determined positions of the hand, the microwave oven can estimate the position(s) of the food item within the cavity. The microwave oven can be installed with a taught algorithm that correlates sensed positions of the hand with the positions of the food item within the cavity that the hand deposited. If the microwave oven determines that the food item was suboptimally placed within the cavity relative to the position of the infrared sensor, then the microwave oven can prompt the user to replace the food item before commencing the heating operation. Or the microwave oven may move the food item automatically to a more optimal position. On the other hand, if the microwave oven determines that the food item was adequately placed within the cavity to permit automatic cooking of the food item, then the microwave oven commences the heating operation. Determining the position or positions of the food item before commencing the heating operation saves time and may improve user satisfaction with the microwave oven.

Other ways to estimate the position of the food item having a similar temperature as the cavity are additionally disclosed herein.

According to one aspect of the present disclosure, a microwave oven includes (a) a cavity configured to accept a food item for heating, the cavity providing an array of positions at which the food item can be placed; (b) an infrared sensor comprising an array of pixels, each pixel configured to generate an output and each pixel corresponding to a different position of the array of positions of the cavity; (c) a human-machine interface configured to provide an instruction to the user; and (d) a controller in communication with the infrared sensor and the human-machine interface, the controller configured: (i) to determine a temperature at each position of the array of positions of the cavity as a function of the output of each pixel of the array of pixels; (ii) to recognize a rise and fall in the temperature at one or more positions of the array of positions within the cavity; (iii) to estimate the position or positions of the array of positions within the cavity that a food item occupies as a function of the one or more positions of the array of positions within the cavity where the controller recognized a rise and fall in temperature occurred; and (iv) to determine whether the position or positions that the food item is estimated to occupy is adequate for the controller to determine accurately a temperature of the food item during an automatic heating operation that utilizes the infrared sensor.

According to another aspect of the present disclosure, a microwave oven comprises: (a) a cabinet comprising a floor, a ceiling, and opposing sidewalls defining a cavity configured to accept a food item for heating and an opening into the cavity from an external environment; (b) one or more sensors positioned to generate output indicative of whether and where laterally an object enters the opening from the external environment into the cavity; (c) a human-machine interface configured to provide an instruction to the user; (d) an infrared sensor configured to determine a temperature of the food item during an automatic heating operation of the food item; and (e) a controller in communication with the one or more sensors and the human-machine interface, the controller configured: (i) to estimate a position or positions within the cavity that a food item occupies as a function of the output of the one or more sensors; and (ii) to determine whether the position or positions that the food item is estimated to occupy is adequate for the controller to determine accurately the temperature of the food item during the automatic heating operation.

According to yet another aspect of the present disclosure, a method of operating a microwave oven comprises: (i) estimating one or more positions within a cavity of a microwave oven that a food item occupies, without first heating the food item within the cavity; and (ii) determining that the one or more positions that the food item is estimated to occupy is suboptimal for the microwave oven to determine accurately, with an infrared sensor of the microwave oven, a temperature of the food item during an automatic heating operation of the food item.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a microwave oven of the present disclosure, illustrating a door and a human-machine interface disposed at the door with a digital display and a speaker;

FIG. 2 is a front elevational view of the microwave oven of FIG. 1, illustrating the door in an open position revealing a cavity to place a food item for heating and an infrared sensor positioned to read the temperature within the cavity;

FIG. 3 is an elevational view of a cross-section of the microwave oven of FIG. 1, illustrating a magnetron to deliver microwaves into the cavity and a motor to turn a turntable of the microwave;

FIG. 4 is a perspective view of the microwave oven of FIG. 1 with the door in the open position, illustrating an array of positions within the cavity where the food item may be positioned for the heating operation thereof;

FIG. 5 is a schematic view of an array of pixels of the infrared sensor of the microwave oven of FIG. 1;

FIG. 6 is a schematic view of the microwave oven of FIG. 1, illustrating a controller of the microwave oven in communication with the infrared sensor, the human-machine interface, the magnetron, and motor for the turntable, among other things;

FIG. 7 is a closer up view of the human-machine interface of the microwave oven of FIG. 1, illustrating the digital display thereof issuing an instruction to the user to reposition the food item within the cavity;

FIG. 8 is an elevational view of a microwave oven, similar to the microwave oven of FIG. 1, but including (i) one or more sensors positioned to sense that an object (such as plate holding a food item) is approaching a cavity of the microwave oven and (ii) a door sensor positioned to sense whether the door is in a closed position or has moved away from the closed position toward an open position;

FIG. 9 is a schematic view of the microwave oven of FIG. 8, illustrating a controller in communication with the one or more sensors, the infrared sensor, a human-machine interface, a magnetron, and a motor for a turntable, among other things;

FIG. 10 is a perspective view of the microwave oven of FIG. 8, illustrating the one or more sensors having different fields of view allowing the controller to determine which region proximate an opening into the cavity an object (e.g., a food item) has entered the cavity;

FIG. 11 is a flow chart of a method of operating a microwave oven, such as the microwave ovens of FIGS. 1 and 8;

FIG. 12, pertaining to Example 1, is a temperature map derived from the output of individual pixels of an infrared sensor of a microwave oven with a mug full of water in the cavity, where the mug, the water, and the cavity were all at about the same temperature (e.g., ambient temperature);

FIG. 13, pertaining to Example 2, is a temperature map derived from the output of individual pixels of an infrared sensor of a microwave oven with a frozen beef patty in the cavity, illustrating that positions within the cavity that the frozen beef patty occupies can be readily identified based on the output of the pixels;

FIG. 14A, pertaining to Example 3A, is a temperature map derived from the output of individual pixels of an infrared sensor of a microwave oven at a moment in time where a hand is depositing a food item within the cavity near the left sidewall of the cavity (e.g., laterally to the left side of the opening into the cavity);

FIG. 14B, pertaining to Example 3B, is a temperature map derived from the output of individual pixels of an infrared sensor of a microwave oven at a moment in time where a hand is depositing a food item within the cavity near the center of the cavity; and

FIG. 14C, pertaining to Example 3A, is a graph plotting a maximum temperature determined from the output of individual pixels of an infrared sensor of a microwave oven as a function of time while a hand is entering the cavity, placing a food item, and exiting the cavity.

The components in the figures are not necessarily to scale, emphasis instead being placed upon illustrating the principles described herein.

### DETAILED DESCRIPTION

The present illustrated embodiments reside primarily in combinations of method steps and apparatus components related to a microwave oven. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

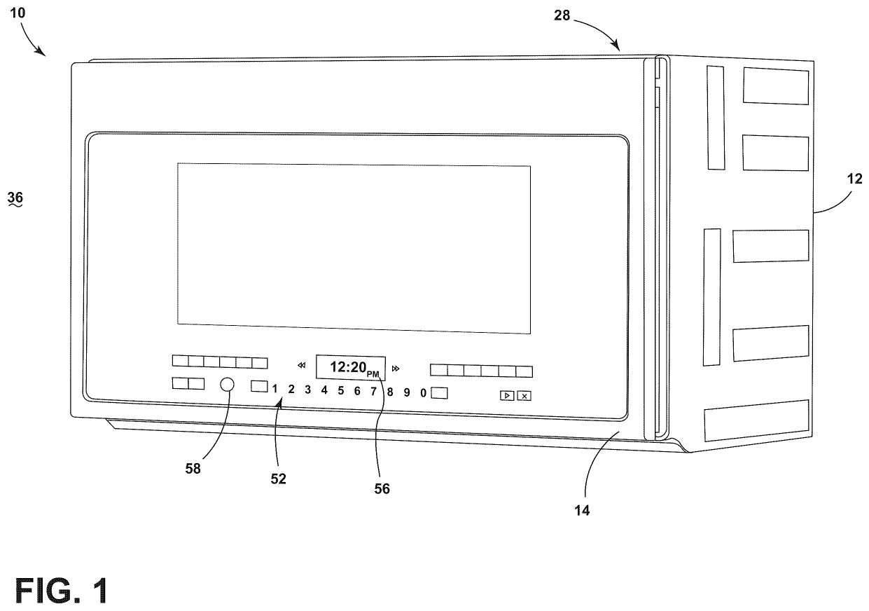

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer (e.g., a user of the microwave), and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprise the element.

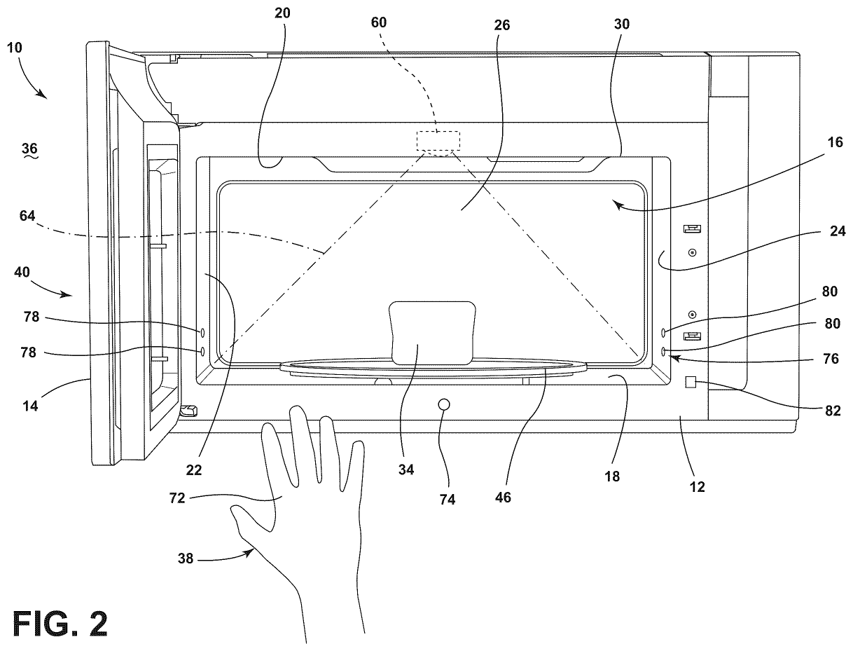

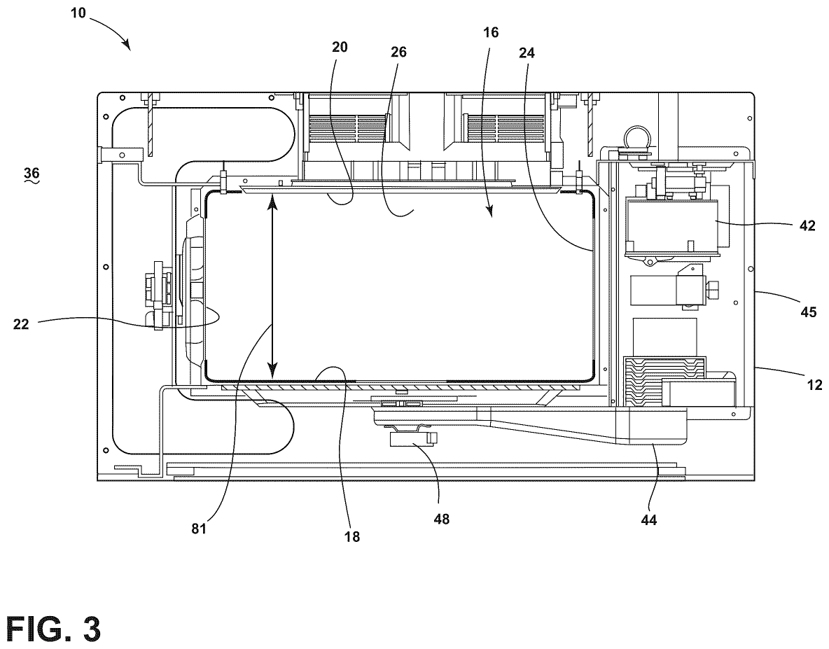

Referring to FIGS. 1-4, a microwave oven 10 includes a cabinet 12 and a door 14 attached to the cabinet 12. The cabinet 12 defines a cavity 16. For example, the cabinet 12 can provide a floor 18 and a ceiling 20 opposing each other, a sidewall 22 and a sidewall 24 opposing each other, and a rear wall 26 that opposes the door 14 when the door 14 is in a closed position 28 (see FIG. 1), which collectively define the cavity 16. The cavity 16 has an opening 30. The floor 18 has a perimeter 32 bound by the sidewalls 22, 24, the rear wall 26, and the opening 30 into the cavity 16. The cavity 16 is configured to accept a food item 34 for heating. For example, the cavity 16 is sized appropriately to accept the food item 34 therein, with sufficient distance between the floor 18 and the ceiling 20, between the sidewalls 22, 24, and between the rear wall 26 and the door 14. In the closed position 28, the door 14 separates the cavity 16 from an external environment 36 and, thus, denies a user 38 access to the cavity 16 from the external environment 36. The door 14 additionally has an open position 40 (see FIG. 2), where the door 14 allows the user 38 access to the cavity 16 from the external environment 36. In the closed position 28, the door 14 covers the opening 30 into the cavity 16. In the open position 40, the door 14 does not cover the opening 30 into the cavity 16. For example, a user 38 is able to place the food item 34 within the cavity 16, when the door 14 is in the open position 40.

The microwave oven 10 further includes a magnetron 42 and a waveguide 44, or some other component to transfer the microwaves from the magnetron 42 to the cavity 16. The magnetron 42 generates the microwaves that heat the food item 34. The magnetron 42 generates the microwaves via a process called electron cyclotron resonance, where a magnetic field accelerates electrons in a circular path within a vacuum tube. As the electrons move in that circular path, the electrons emit in-phase microwaves having the same frequency. The waveguide 44 guides the microwaves that the magnetron 42 emitted into the cavity 16. The waveguide 44 can be a tube made of metal, such as copper or aluminum. The magnetron 42 and waveguide 44 can be disposed between the cavity 16 (e.g., the side wall and/or floor 18 thereof) and an outer wall 45 of the cabinet 12.

In embodiments, the microwave oven 10 further includes a turntable 46 and a motor 48 coupled to the turntable 46. The turntable 46 is disposed within the cavity 16. The motor 48 can be disposed within the cabinet 12, under the floor 18 of the cavity 16. The turntable 46 can be made of glass or some other heat-resistant material. When activated, the motor 48 causes the turntable 46 to rotate.

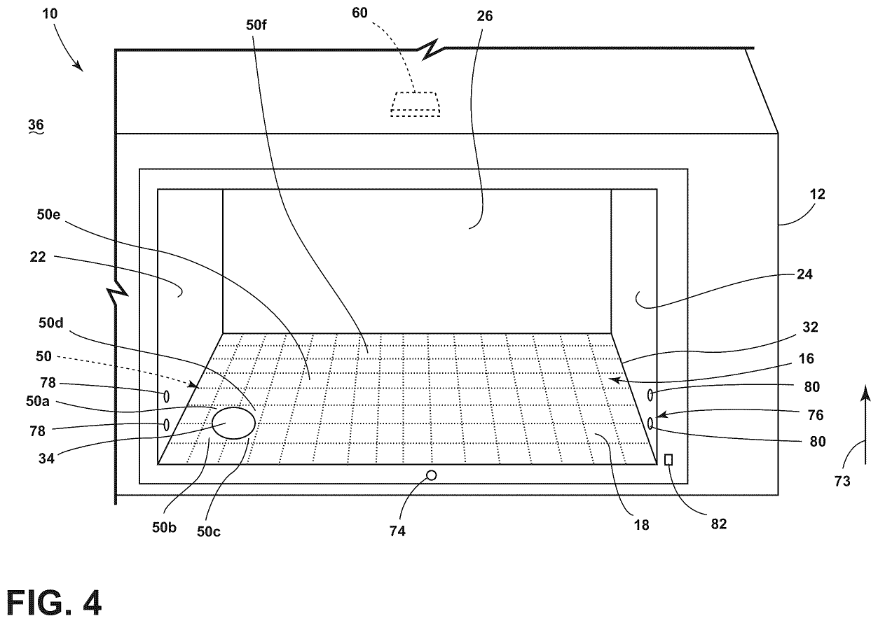

The cavity 16 provides an array 50 of positions 50a, 50b, . . . 50n at which the user 38 can place the food item 34. The array 50 of positions 50a, 50b, . . . 50n is generally coextensive with a horizontal plane just above the floor 18, or in embodiments of the microwave oven 10 that include the turntable 46, a horizontal plane just above the turntable 46. To illustrate, the food item 34 illustrated at FIG. 4 is placed at positions 50a-50d. However, the food item 34 is not placed at the position 50e or any other position 50n of the array 50.

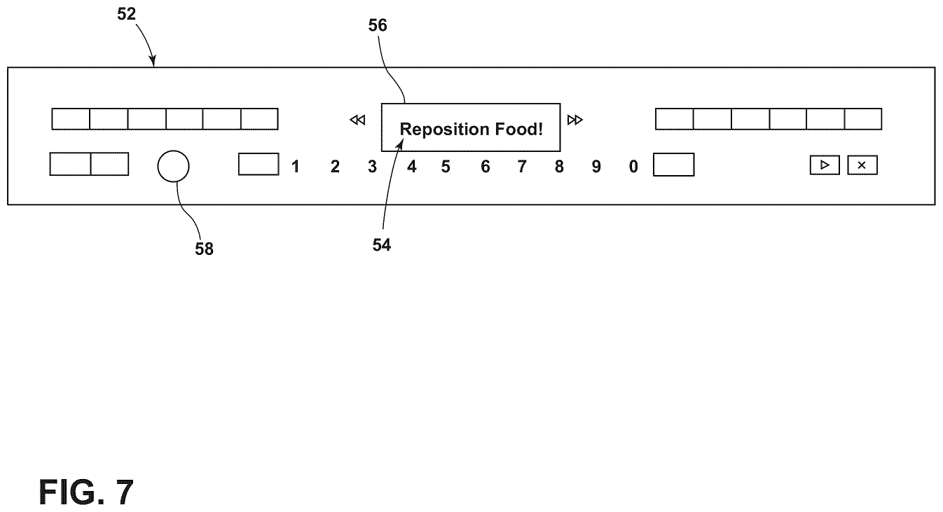

The microwave oven 10 further includes a human-machine interface 52. The human-machine interface 52 is configured to provide an instruction 54 (see FIG. 7) to the user 38. In embodiments, the human-machine interface 52 includes a digital display 56, at which the instruction 54 to the user 38 can be displayed. In addition, the human-machine interface 52 can include a speaker 58 to provide the instruction 54 to the user 38 audibly. The content of the instruction 54 will be further described below. In embodiments, the human-machine interface 52 is available at the door 14 of the microwave oven 10. In other environments, the human-machine interface 52 is disposed at the cabinet 12.

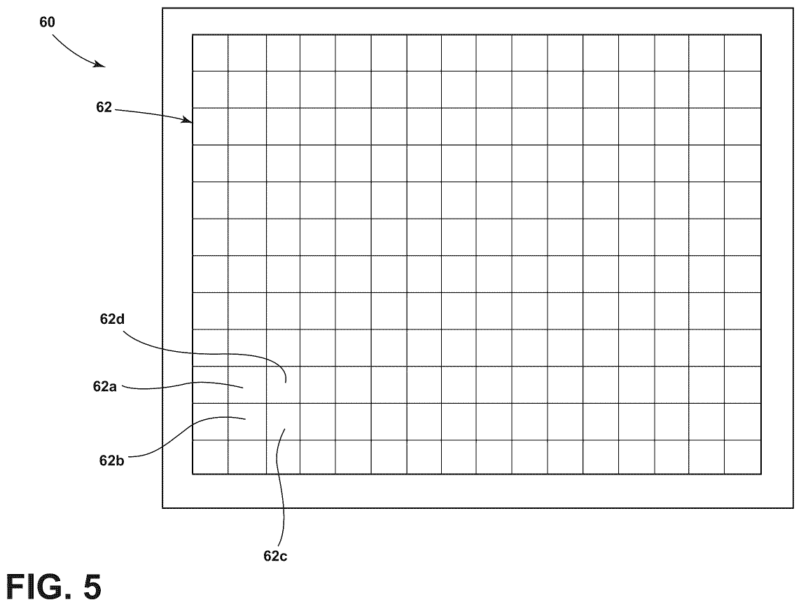

Referring additionally to FIG. 5 the microwave oven 10 further includes an infrared sensor 60. The infrared sensor 60 includes an array 62 of pixels 62a, 62b, . . . 62n. Each pixel 62n corresponds to a different position 50n of the array 50 of positions 50a, 50b, . . . 50n of the cavity 16. For example, the pixel 62a corresponds to the position 50a, the pixel 62b corresponds to the position 50b, the pixel 62c corresponds to the position 50c, and the pixel 62d corresponds to the position 50d. In embodiments, the infrared sensor 60 has a field a view 64 that encompasses at least the perimeter 32 of the floor 18 of the cavity 16. Accordingly, the array 62 of pixels 62a, 62b, . . . 62n will at least encompass the array 50 of positions 50a, 50b, . . . 50n of the cavity 16. The infrared sensor 60 can be mounted above the ceiling 20, with the cavity 16 visible through a window that is sufficiently transparent to infrared electromagnetic radiation. Each pixel 62n generates an output.

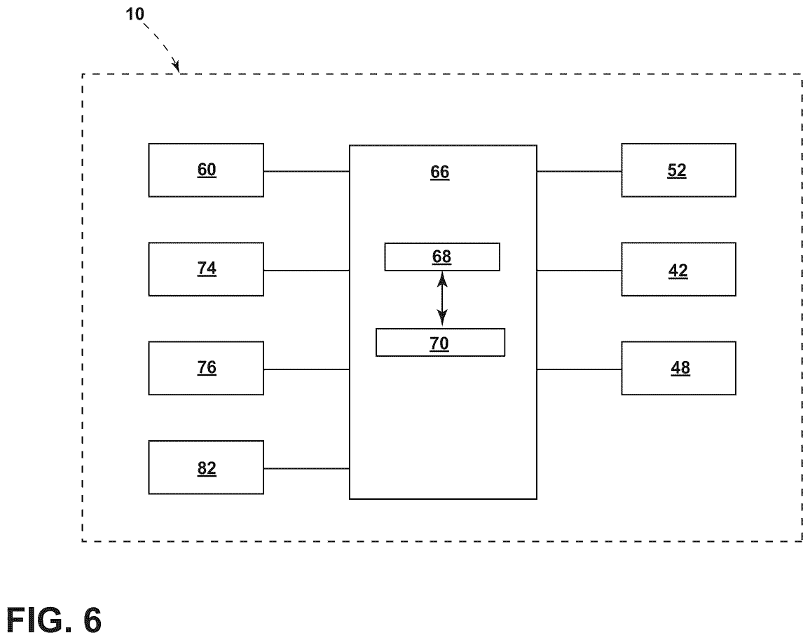

Referring additionally to FIG. 6, the microwave oven 10 further includes a controller 66. The controller 66 can be housed in the cabinet 12. In other embodiments, the controller 66 is housed in the door 14. The controller 66 is in communication with the human-machine interface 52, the infrared sensor 60, the magnetron 42, and the motor 48 that moves the turntable 46, among other components as herein described. The communication can be via wired or wireless means (e.g., Wi-Fi, Bluetooth, and Zigbee), or a combination thereof.

The controller 66 controls the output of the human-machine interface 52, such as the digital display 56 and the speaker 58, if included. The controller 66 includes memory 68 and a processor 70. The memory 68 stores programs and data, such as from the infrared sensor 60 and the human-machine interface 52, that the processor 70 executes in furtherance of the controller 66 actions described herein. The memory 68 can be random access memory (RAM), read-only memory (ROM), and flash memory, among other possibilities. The processor 70 can be a microprocessor or a microcontroller, among other possibilities.

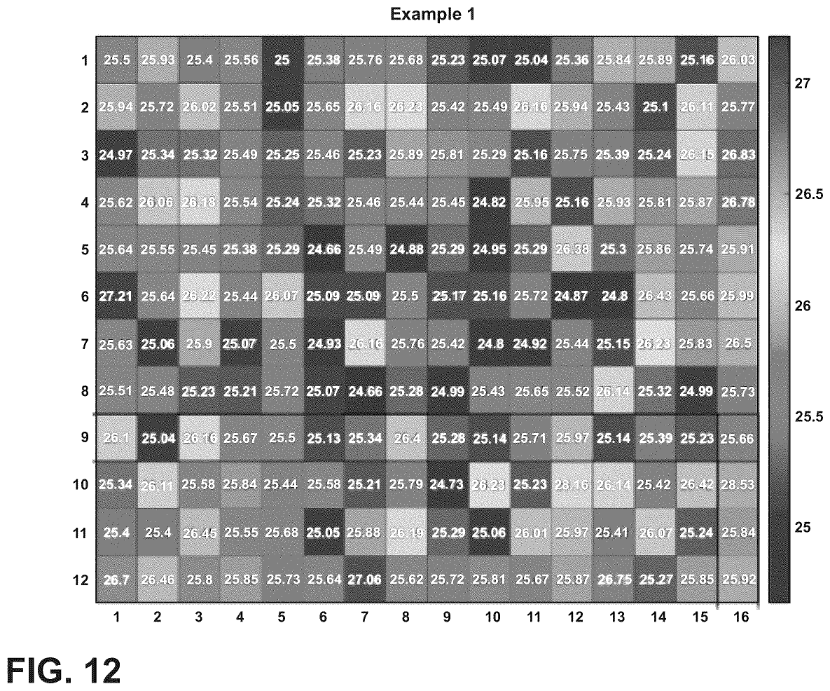

The controller 66 receives and processes the outputs that the infrared sensor 60 generates. More specifically, each pixel 62n of the array 62 of pixels 62a, 62b, . . . 62n of the infrared sensor 60 generates output that the controller 66 receives. The output of each pixel 62n, typically a voltage, is proportional to the incident infrared energy, which in turn is proportional to the temperature. Accordingly, the controller 66 can determine a temperature at each position 50n of the cavity 16 as a function of the output of each pixel 62n that correlates to that particular position 50n. The output of each pixel 62n is indicative of the temperature at the position 50n in the cavity 16 to which the pixel 62n corresponds. The controller 66 can thus determine a heat map (see e.g., FIG. 12) of the cavity 16 corresponding to the temperature at each of the positions 50a, 50b, . . . 50n of the cavity 16.

The controller 66 is further configured to identify a rise and fall in the temperature at one or more of the positions 50n of the array 50 of positions 50a, 50b, . . . 50n within the cavity 16. By monitoring the output that each pixel 62n of the array 62 of pixels 62a, 62b, . . . 62n of the infrared sensor 60 generates as a function of time, the controller 66 can identify a short term change in output, for example, a rise and fall in voltage generated by one or more of the pixels 62a, 62b, . . . 62n as a function of time. Because the array 62 of pixels 62a, 62b, . . . 62n corresponds to the array 50 of positions 50a, 50b, . . . 50n within the cavity 16, the short term change in output, such as the rise and fall in voltage, can be equated with a rise and fall in temperature at the one or more positions 50a, 50b, . . . 50n corresponding to the one or more pixels 62a, 62b, . . . 62n showing the short term change in output. In embodiments, the controller 66 can be configured to require a certain number of contiguous pixels 62a, 62b, . . . 62n generate a similar short term change in output as requisite to identifying a rise and fall in temperature. Other filters could be utilized to eliminate noise at the level of individual pixels 62a, 62b, . . . 62n.

In embodiments, the rise and fall in the temperature at the one or more positions 50a, 50b, . . . 50n that the controller 66 is configured to recognize include rising from about room temperature to above 30° C. and then back to about room temperature. The temperature of the cavity 16 will likely be equalized with room temperature. Thus, room temperature here literally can mean the temperature of the external environment 36 (e.g., a room, a kitchen) in which the microwave oven 10 is located. In some instances, room temperature may be about 20° C., but can be colder or warmer in other instances. A hand 72 of the user 38 in the external environment 36 having a room temperature of about 20° C. will typically have a temperature of about 32° C. to about 34° C. However, the temperature of the hand 72 can be lower than 32° C. under a variety of circumstances, such as when the external environment 36 is cooler than 20° C. Thus, the temperature of 30° C. is a reasonable minimum value for the signature of the hand 72. In some instances, the temperature can be lower than 30° C.

The rise and fall of the temperature that the controller 66 is configured to recognize can occur over a predefined time period. The user 38 action of placing the food item 34 within the cavity 16 takes a finite amount of time. If the rise and fall of the temperature is too quick—shorter than the predefined time period—then the controller 66 can be configured to disregard the rise and fall as noise. In some instances, the predefined period of time can be within a range of from 0.5 second to 10 seconds, although a period of time outside of that range may be appropriate.

The controller 66 is further configured to estimate the position 50n or positions 50a, 50b, . . . 50n of the array 50 of positions 50a, 50b, . . . 50n within the cavity 16 that a food item 34 occupies as a function of the one or more positions 50a, 50b, . . . 50n of the array 50 of positions 50a, 50b, . . . 50n within the cavity 16 where the controller 66 recognized a rise and fall in temperature occurred. As mentioned, the rise and fall of temperature at the one or more positions 50a, 50b, . . . 50n within the cavity 16 indicates the hand 72 of the user 38 entering the cavity 16 to deposit the food item 34 within the cavity 16 (e.g., upon the floor 18 or turntable 46) and then leaving the cavity 16 to return to the external environment 36. A trained algorithm can be generated that correlates the positions 50a, 50b, . . . 50n that the hand 72 of the user 38 occupied, as a function of time, while depositing the food item 34 into the cavity 16 with the positions 50a, 50b, . . . 50n that the food item 34 occupies after being so deposited. Various different hand 72 postures and entries into the cavity 16 can be correlated with different containers for the food item 34, sizes of containers, and the positions 50a, 50b, . . . 50n that the food item 34 occupies within the cavity 16. The signature, in terms of positions 50a, 50b, . . . 50n within the cavity 16 as a function of time, of the hand 72 depositing a cup of soup into the cavity 16 is different than the signature of the hand 72 depositing a plate of some food item 34. The signature of a hand 72 depositing a small plate is different than the signature of a hand 72 depositing a large plate, and so on.

There are various machine learning techniques that can be utilized to generate the trained algorithm that can predict the positions 50a, 50b, . . . 50n of the food item 34 as a function of the positions 50a, 50b, . . . 50n that the hand 72 occupies while entering and leaving the cavity 16. Supervised learning is an example, where datasets of examples are provided with the food item 34 and the hand 72 labeled. Once the algorithm is trained to predict the positions 50a, 50b, . . . 50n of the food item 34 within the cavity 16 and a function of the position of the hand 72, the trained algorithm can be further taught to equate output from the pixels 62a, 62b, . . . 62n of the infrared sensor 60 with the positions 50a, 50b, . . . 50n of the hand 72 in a similar manner. The trained algorithm would thus be able to predict the positions 50a, 50b, . . . 50n of the food item 34 within the cavity 16 as a function of the outputs of the pixels 62a, 62b, . . . 62n of the infrared sensor 60. The trained algorithm is stored in memory 68 for the controller 66 to access and utilize while receiving output from the pixels 62a, 62b, . . . 62n of the infrared sensor 60 in order to estimate the position 50n or positions 50a, 50b, . . . 50n that the food item 34 occupies.

In embodiments, the machine learning technique utilizes a deep learning neural network. A deep learning neural network can be used to identify regions of interest in images. One example deep learning network is VGG16. VGG16 is a convolutional neural network architecture that can analyze an image, extract features therefrom, and pass the extracted features through a series of connected layers, which predict the content of the extracted features. For purposes of this disclosure, the VGG16 architecture can accept, as input, the output from the pixels 62a, 62b, . . . 62n of the infrared sensor 60 and extract features therefrom, pass them through the series of connected layers, and conclude whether and where the hand 72 is positioned within the cavity 16—for example, which of the positions 50a, 50b, . . . 50n the hand 72 occupies.

Another example deep learning network is YOLO (short for You Only Look Once). The YOLO architecture processes an image (here, the output from the pixels 62a, 62b, . . . 62n of the infrared sensor 60 at a point in time) and predicts the location and classification of objects (e.g., the hand 72) within the image. YOLO architecture allows for real-time or near real-time object detection from input image data. YOLO divides the input into a grid of cells and determines the presence of desired object(s) (e.g., the hand 72) within each cell via a convolutional neural network. Thus, the YOLO architecture could identify that the hand 72 is within the cavity 16 and track the movement thereof—for example which of the positions 50a, 50b, . . . 50n the hand 72 occupies as a function of time.

Other architectures can be considered with the objective of reducing the size and complexity of the network. This can depend on the type of sensor used, as the dimensions of the raw image can be different, changing the architecture of the neural network. A simplified version of the algorithm can be extracting elements of the temperature blob, like size, direction, angle, etc. This can be achieved by applying a clustering algorithm on the image and separate background from object, then extracting the elements mentioned above from the object.

In embodiments, the controller 66 is configured so that the positions 50a, 50b, . . . 50n that the controller 66 estimates the food item 34 occupies are different than the positions 50a, 50b, . . . 50n where the controller 66 recognized the rise and fall in temperature occurred. This can be a consequence of the trained algorithm. As an example, consider the user 38 placing a plate holding the food item 34 into the cavity 16. At the greatest progression of the hand 72 into the cavity 16, the hand 72 occupies one set of positions 50a, 50b, . . . 50n within the cavity 16 while the food item 34 occupies another set of positions 50a, 50b, . . . 50n within the cavity 16. In many instances, the hand 72 within the cavity 16 and the food item 34 do not fully overlap. In embodiments, the controller 66 estimates that the food item 34 occupies a position 50n or positions 50a, 50b, . . . 50n that are directly rearward 73 of the one or more positions 50a, 50b, . . . 50n where the controller 66 recognized the rise and fall in temperature occurred—for example, the food item 34 is estimated to be closer to the rear wall 26 than the one or more positions 50a, 50b, . . . 50n where the controller 66 recognized the rise and fall in temperature occurred. There are likely exceptions, such as the hand 72 palming the food item 34, such as a biscuit. Thus, in embodiments, the controller 66 estimates that the food item 34 occupies a position 50n or positions 50a, 50b, . . . 50n that are coextensive with or subsumed by the one or more positions 50a, 50b, . . . 50n where the controller 66 recognized the rise and fall in temperature occurred.

The controller 66 is further configured to determine whether the position 50n or positions 50a, 50b, . . . 50n that the food item 34 is estimated to occupy is adequate for the controller 66 to determine accurately a temperature of the food item 34 during an automatic heating operation that utilizes the infrared sensor 60. As mentioned, the microwave oven 10 is capable of heating the food item 34 without the user 38 having to set a fixed time of heating (e.g., 3 minutes). The microwave oven 10 performs that automatic heating function relying on the output from the infrared sensor 60, from which the temperature of the food item 34 can be determined. Once a desirable temperature is achieved, the microwave oven 10 ceases the heating operation. However, the further the food item 34 is from the infrared sensor 60, the less accurate the output of infrared sensor 60. In other words, the pixels 62a, 62b, . . . 62n of the infrared sensor 60 positioned to generate output correlating with positions 50a, 50b, . . . 50n within the cavity 16 further away from infrared sensor 60 generate output that is less accurate than the output generated by pixels 62a, 62b, . . . 62n correlated with positions 50a, 50b, . . . 50n within the cavity 16 closer to the infrared sensor 60. Various positions 50a, 50b, . . . 50n within the cavity 16 can be predetermined as being too far from the infrared sensor 60. If the controller 66 estimates that the food item 34 occupies those positions 50a, 50b, . . . 50n that are too far away from the infrared sensor 60, then the controller 66 determines that the positions 50a, 50b, . . . 50n are inadequate for the controller 66 to determine accurately the temperature of the food item 34 during the automatic heating operation. However, if the controller 66 estimates that the food item 34 does not occupy those positions 50a, 50b, . . . 50n that are too far from the infrared sensor 60, then the controller 66 determines that the positions 50a, 50b, . . . 50n are adequate for the controller 66 to determine accurately the temperature of the food item 34 during the automatic heating operation.

The controller 66 is configured to perform these described actions (e.g., to determine the temperature at each position 50n, to recognize the rise in fall in temperature, to estimate the positions 50a, 50b, . . . 50n that the food item 34 occupies, and to determine whether the positions 50a, 50b, . . . 50n are adequate for automatic heating) without first activating the magnetron 42 to increase the temperature of the food item 34. As mentioned, instead of performing those actions, the controller 66 could activate the magnetron 42 and heat the food item 34 until the temperatures of the food item 34 and the cavity 16 respectively contrast sufficiently for the controller 66 to ascertain the positions 50a, 50b, . . . 50n of the food item 34. However, that takes time. And if the positions 50a, 50b, . . . 50n of the food item 34 are inadequate to perform the automatic heating operation, then the microwave oven 10 would have to cease the heating operation and call for the user 38 to reposition the food. The approach of the present disclosure results in the controller 66 making the decision as to whether the positions 50a, 50b, . . . 50n of the food item 34 are adequate for the automatic heating operation without first causing the magnetron 42 to heat the food item 34.

Referring now to FIG. 7, in embodiments, the controller 66 is further configured to cause the human-machine interface 52 to issue the instruction 54 to the user 38. In embodiments, the instruction 54 to the user 38 is to reposition the food item 34 within the cavity 16. The repositioning of the food item 34 is so that the food item 34 occupies a position 50n or positions 50a, 50b, . . . 50n that are adequate for the controller 66 to determine accurately the temperature of the food item 34 during the automatic heating operation. After the user 38 repositions the food item 34, the controller 66 again (i) recognizes the rise and fall in at one or more positions 50a, 50b, . . . 50n within the cavity 16 due to the hand 72 entering the cavity 16 and (ii) estimates the positions 50a, 50b, . . . 50n within the cavity 16 that the food item 34 occupies. In embodiments, the algorithm that the controller 66 utilizes is specifically trained with repositioning data, as the hand 72 movement and posture during repositioning may be different than the hand 72 movement and posture during the initial positioning of the food item 34 within the cavity 16. The human-machine interface 52 can utilize the digital display 56 to issue the instruction 54 visibly, the speaker 58 to issue the instruction 54 audibly, or a combination of the two. After the user 38 repositions the food item 34 to an adequate position 50n or positions 50a, 50b, . . . 50n, then the controller 66 commences the automatic heating operation.

In embodiments, the controller 66 is further configured to cause the motor 48 to rotate the turntable 46 to reposition the food item 34 within the cavity 16 to occupy a position 50n or positions 50a, 50b, . . . 50n that is adequate for the controller 66 to determine accurately the temperature of the food item 34 during the automatic heating operation. For example, if the controller 66 determines that the food item 34 occupying position 50e (see FIG. 4) is inadequate, and that position 50f would be adequate, then the controller 66 can cause the turntable 46 to rotate the food item 34 from the position 50e to the position 50f. After the turntable 46 repositions 50a, 50b, . . . 50n the food item 34 to an adequate position 50n or positions 50a, 50b, . . . 50n, then the controller 66 commences the automatic heating operation.

Referring back to FIGS. 2 and 4, in embodiments, the microwave oven 10 includes a time of flight sensor 74. The time of flight sensor 74 is positioned to generate output from which it can be determined whether an object, such as the hand 72 of the user 38, is approaching the cavity 16 of the microwave. For example, the time of flight sensor 74 can be placed at the cabinet 12 inside the door 14 elevationally, such as elevationally lower than the floor 18 of the cavity 16 or elevationally higher than the ceiling 20 of the cavity 16. The time of flight sensor 74 utilizes a light or radio signal to travel from the sensor to the object and back to the sensor again. The time of flight sensor 74 can be a LIDAR sensor or an ultrasonic sensor, among other options. The controller 66 can use the output of the time of flight sensor 74 to determine that an object, such as the hand 72 of the user 38 with the food item 34, is approaching the cavity 16. In embodiments, the controller 66 determines, as a function of the output of the time of flight sensor 74, that an object is approaching the cavity 16 before analyzing the output from the array 62 of pixels 62a, 62b, . . . 62n of the infrared sensor 60 to determine the temperature at each position 50n within the cavity 16 and before attempting to recognize whether there has been a rise and fall in temperature at any of the positions 50a, 50b, . . . 50n. The controller 66 can utilize the output of the time of flight sensor 74 as a cue to begin processing the output from the infrared sensor 60. If no object is approaching the cavity 16, then there is no need for the controller 66 to expend resources to process the output of the infrared sensor 60. If an object is approaching the cavity 16, as determined via analyzing the output of the time of flight sensor 74, then the controller 66 can begin processing the output from the infrared sensor 60. The time of flight sensor 74 can increase the energy efficiency of the microwave oven 10.

In embodiments, the microwave oven 10 includes a light curtain 76. The light curtain 76 includes one or more pairs of a transmitter 78 of electromagnetic radiation and a receiver 80 of electromagnetic radiation. One transmitter 78 is paired with one receiver 80, another transmitter 78 is paired with another receiver 80, and so on. The electromagnetic radiation that the transmitter 78 is configured to emit, and that the receiver 80 is configured to receive, can be red visible light or infrared radiation, among other options. The light curtain 76 is in communication with the controller 66.

The light curtain 76 is positioned to generate output from which the controller 66 can determine whether an object (e.g., a hand 72, a plate with the food item 34, etc.) has crossed, or is about to cross, the opening 30 into the cavity 16. For example, the one or more pairs of the transmitter 78 and the receiver 80 can be disposed proximate the opening 30 into the cavity 16, such as just inside the cavity 16 at the sidewall 22 and the sidewall 24 respectively. The pairs of transmitters 78 and receivers 80 can be positioned elevationally, in a spaced apart fashion, along a height 81 of the cavity 16 from the floor 18 to the ceiling 20. The positioning of, and the elevational distance between adjacent, transmitters 78 and receivers 80 ought to be sufficient to detect an object regardless of where elevationally the object crosses the opening 30 into the cavity 16 (e.g., sufficient to detect the object crossing substantially anywhere along the height 81). The transmitter 78 emits electromagnetic radiation that the receiver 80 is positioned to receive. The receiver 80 generates an output that changes as a function of whether the receiver 80 is receiving the electromagnetic radiation that the transmitter 78 emits. If an object is not disposed between the transmitter 78 and the receiver 80, then the receiver 80 receives the electromagnetic radiation that the transmitter 78 transmits. In contrast, if an object is disposed between the transmitter 78 and the receiver 80, then the receiver 80 does not receive the electromagnetic radiation that the transmitter 78 transmits, and the output of the receiver 80 changes compared to when the receiver 80 was receiving the electromagnetic radiation. The controller 66 can thus recognize the change in output of the receiver 80 and conclude that an object has crossed the opening 30 into the cavity 16.

In embodiments, the controller 66 determines, as a function of the output of the light curtain 76, that an object has crossed the opening 30 into the cavity 16 before analyzing the output from the array 62 of pixels 62a, 62b, . . . 62n of the infrared sensor 60 to determine the temperature at each position 50n within the cavity 16 and before attempting to recognize whether there has been a rise and fall in temperature at any of the positions 50a, 50b, . . . 50n. The controller 66 can utilize the output of the receiver 80 of the light curtain 76 as a cue to begin processing the output from the infrared sensor 60. If no object has crossed the opening 30 into the cavity 16, then there is no need for the controller 66 to expend resources to process the output of the infrared sensor 60. If an object has crossed the opening 30 into the cavity 16, as determined via analyzing the output of the light curtain 76, then the controller 66 can begin processing the output from the infrared sensor 60. In many scenarios, a food item 34 (or container or dishware holding the food item 34) crosses the opening 30 into the cavity 16 before the hand 72. Thus, in many scenarios, the controller 66 will have sufficient time to analyze the output from the infrared sensor 60 to determine the presence and signature of the hand 72 after noticing a change in output of the light curtain 76 due to the food item 34.

In embodiments, the microwave oven 10 includes a door sensor 82. The door sensor 82 is in communication with the controller 66. The door sensor 82 generates an output that changes as a function whether the door 14 is in the closed position 28 or the open position 40. For example, the door sensor 82 can include a magnet coupled to the door 14 and a reed switch coupled to the cabinet 12 near where the magnet is when the door 14 is in the closed position 28. When the door 14 is in the closed position 28, a magnetic field of the magnet closes metal reeds of the reed switch to contact and close an electrical circuit in communication with the controller 66. When the door 14 moves to the open position 40, the metal reeds separate and the electrical circuit becomes open. The controller 66 notices the change in output and can thus deduce whether the door 14 is in the closed position. Other arrangements than the magnet and reed switch are possible for the door sensor 82.

In embodiments, the controller 66 is further configured to determine, as a function of the output generated by the door sensor 82, that the door 14 has moved away from the closed position 28 toward the open position 40 before determining the temperature at each position of the array 50 of positions 50a, 50b, . . . 50n of the cavity 16 and before attempting to recognize whether there has been a rise and fall in temperature at any of the positions 50a, 50b, . . . 50n. The controller 66 can utilize the output of the door sensor 82 as a cue to begin processing the output from the infrared sensor 60. If the door 14 is in the closed position 28, then there is no need for the controller 66 to expend resources to process the output of the infrared sensor 60. The user 38 cannot place a food item 34 into the cavity 16 from the external environment 36 when the door 14 is in the closed position. If the door 14 has moved away from the closed position 28 toward the open position 40, as determined via analyzing the output of the door sensor 82, then the controller 66 can begin processing the output from the infrared sensor 60.

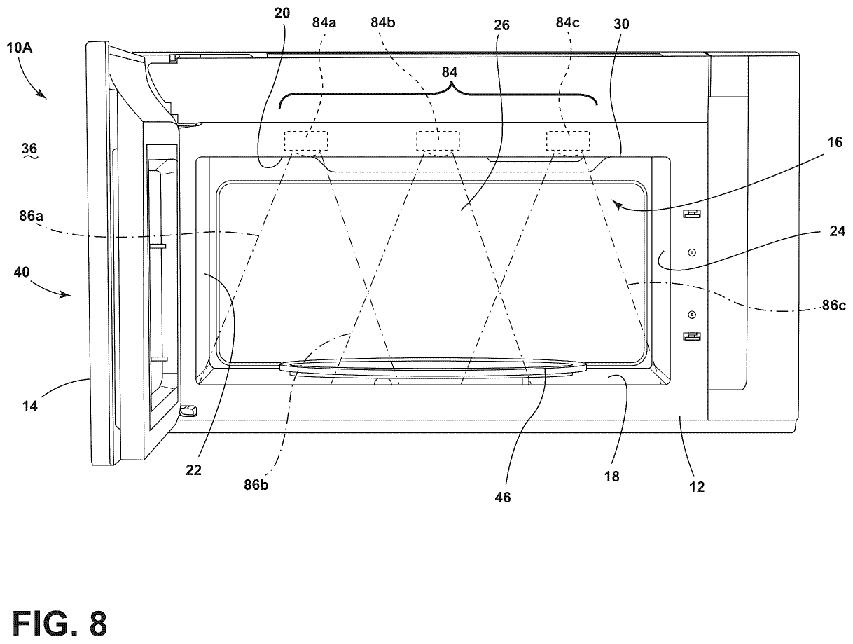

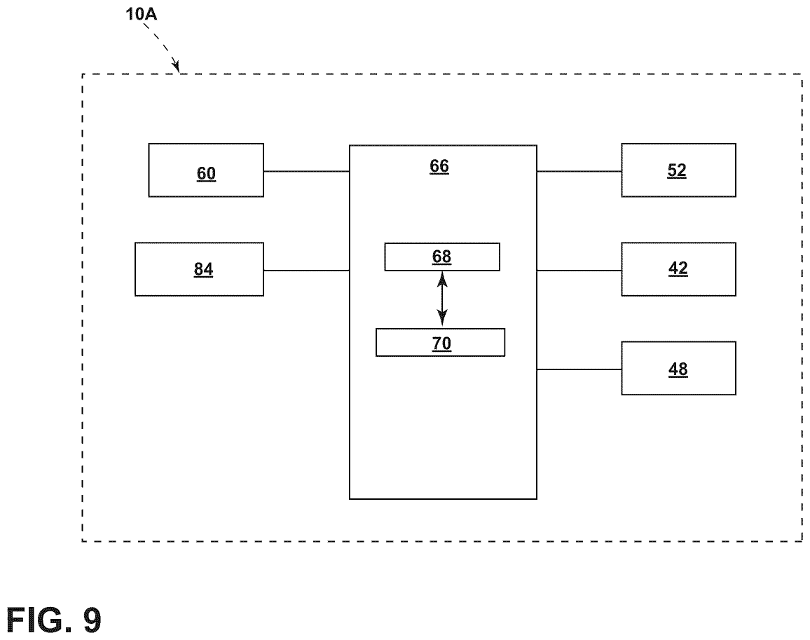

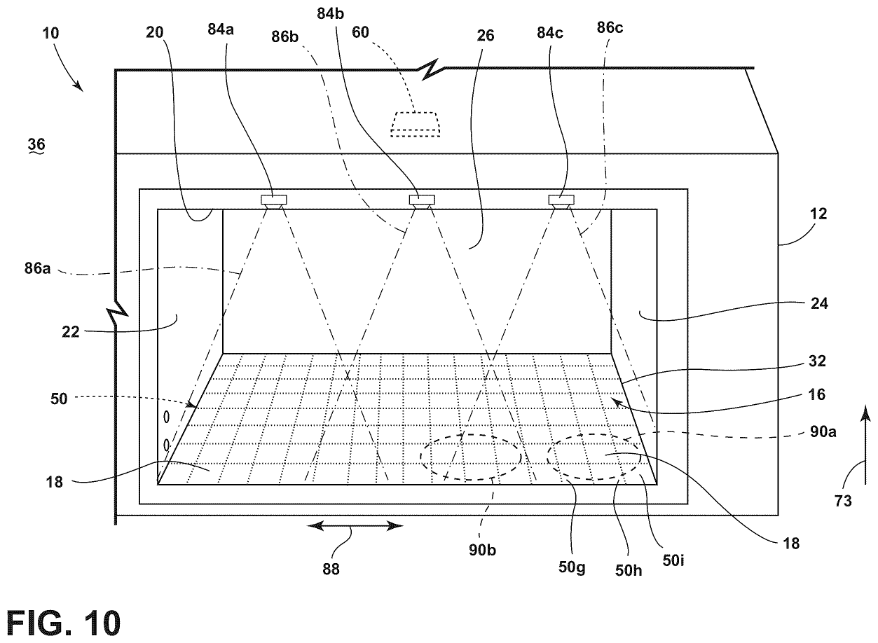

Referring now to FIGS. 8-10, in another embodiment of the microwave oven 10A, instead of utilizing the output generated by the array 62 of pixels 62a, 62b, . . . 62n of the infrared sensor 60 to estimate the position 50n or positions 50a, 50b, . . . 50n that the food item 34 occupies as with the microwave oven 10, the controller 66 can rely upon one or more sensors 84 (other than the infrared sensor 60). The one or more sensors 84 are in communication with the controller 66. The microwave oven 10A can otherwise be the same as the microwave oven 10 described above, without the need to restate the above discussion and drawings. The microwave oven 10A still includes the infrared sensor 60 to determine the temperature of the food item 34 during the automatic heating operation of the food item 34 but not to determine the position 50n or positions 50a, 50b, . . . 50n of the food item 34 before the automatic heating operation begins.

In embodiments, the one or more sensors 84 can include at least three sensors 84a-84c. Each of the at least three sensors 84a-84c has a field of view 86a-86c that is different than the field of view 86a-86c of the other sensors 84a-84c of the at least three sensors 84a-84c. For example, the sensor 84a can have a field of view 86a, the sensor 84b can have a field of view 86b, and the sensor 84c can have a field of view 86c. In some instances, the adjacent fields of view 86a-86c overlap. The fields of view 86a-86c can include the opening 30 into the cavity 16 and the external environment 36 adjacent to the opening 30 when the door 14 is in the open position 40. The at least three sensors 84a-84c can include time of flight sensors, a light curtain, one-pixel infrared sensors, among other options.

The one or more sensors 84 are positioned to generate output that is indicative of whether and where laterally 88 (e.g., where between the sidewalls 22, 24) an object enters the opening 30 from the external environment 36 into the cavity 16. For example, in the illustrated scenario with the at least three sensors 84a-84c, the object entering the opening 30 into the cavity 16 through a region 90a would cause a change in output of the sensor 84c because the region 90a is within the field of view 86c of the sensor 84c. The controller 66 can then understand that an object, such as plate holding a food item 34, is entering the cavity 16 from that region 90a. The object entering the opening 30 into the cavity 16 through a region 90b would cause a change in output of both the sensor 84b and the sensor 84c. The controller 66 can then understand that the object is entering the cavity 16 from that region 90b. The greater the number of sensors 84, the more precisely the controller 66 can determine from changes in output of the sensors 84 the region 90n where the object crosses the opening 30 into the cavity 16 from the external environment 36.

In turn, the controller 66 can estimate the position 50n or positions 50a, 50b, . . . 50n within the cavity 16 that the food item 34 occupies as a function of the output of the one or more sensors 84. After the controller 66 determines the region 90n where the object crosses the opening 30 into the cavity 16 from the external environment 36, the controller 66 can estimate the position 50n or positions 50a, 50b, . . . 50n at which the object (e.g., the food item 34) resides within the cavity 16. This correlation between region 90n of entry into the cavity 16 and position 50n or positions 50a, 50b, . . . 50n within the cavity 16 that the object (e.g., food item 34) is estimated to reside can be predetermined. For example, after the controller 66 determines that the object (e.g., the food item 34) entered the cavity 16 via the region 90a, the controller 66 can estimate that the object resides at one or more of the positions 50n in the columns of positions 50n rearward 73 of positions 50g-50i adjacent to the opening 30. In embodiments, the controller 66 is configured to estimate that the food item 34 occupies positions 50n rearward 73 of the positions 50n adjacent to the region 90n where the food item 34 crossed the opening 30 into the cavity 16. In embodiments, the controller 66 estimates the position 50n or positions 50a, 50b, . . . 50n of the food item 34 within the cavity 16 as a function of which of the at least three sensors 84a-84c generated output indicative of the object entering the opening 30 into the cavity 16.

The controller 66 is further configured to determine whether the position 50n or positions 50a, 50b, . . . 50n that the food item 34 is estimated to occupy is adequate for the controller 66 to determine accurately a temperature of the food item 34 during the automatic heating operation that utilizes the infrared sensor 60. It can be predetermined, for example, that a food item 34 placed relatively close to the sidewalls 22, 24, such as occupying the columns of positions 50n rearward 73 of the positions 50g-50i in the illustrated scenario, is inadequately positioned for the controller 66 to determine accurately a temperature of the food item 34 during the automatic heating operation. In some instances, the positions 50a, 50b, . . . 50n that are inadequate for the controller 66 depend on the location of the infrared sensor 60.

As with the microwave oven 10, the controller 66 for the microwave oven 10 is further configured to cause the human-machine interface 52 to issue the instruction 54 to the user 38 to reposition the food item 34 to occupy a position 50n or positions 50a, 50b, . . . 50n that is adequate for the controller 66 to determine accurately the temperature of the food item 34 during the automatic heating operation. After the user 38 does so, and moves the door 14 to the closed position 28, the controller 66 initiates the magnetron 42 and performs the automatic heating operation until the controller 66 determines, based on the output from the infrared sensor 60, that the food item 34 has reached a desired temperature.

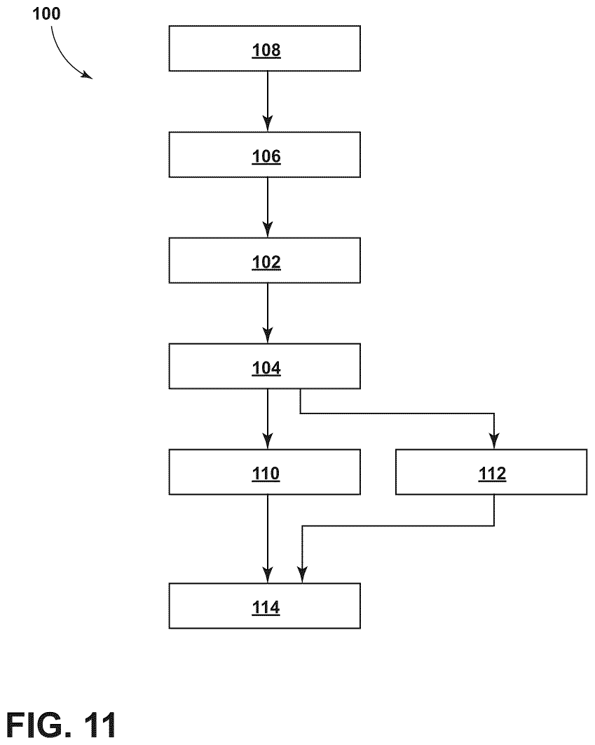

Referring now to FIG. 11, a method 100 of operating a microwave oven (such as the microwave oven 10 or the microwave oven 10A) is herein disclosed. At a step 102, the method 100 includes estimating the position 50n or positions 50a, 50b, . . . 50n within the cavity 16 that the food item 34 occupies, without first heating the food item 34 within the cavity 16. As further elaborated above, in embodiments, estimating the position 50n or positions 50a, 50b, . . . 50n that the food item 34 occupies includes (i) determining a temperature at each of the positions 50a, 50b, . . . 50n within the cavity 16, (ii) recognizing a rise and fall in the temperature at one or more of the positions 50a, 50b, . . . 50n within the cavity 16, and (iii) estimating the position 50n or positions 50a, 50b, . . . 50n within the cavity 16 that the food item 34 occupies as a function of the one or more positions 50a, 50b, . . . 50n where the rise and fall in temperature was recognized to occur.

The temperature at each of the positions 50a, 50b, . . . 50n within the cavity 16 can be determined with the infrared sensor 60 of the microwave oven 10. The output that the pixels 62a, 62b, . . . 62n of the infrared sensor 60 generates can be utilized to determine the temperature at the positions 50a, 50b, . . . 50n within the cavity 16, although other ways are possible. Recognizing the rise and fall in temperature can be achieved by monitoring the output of the pixels 62a, 62b, . . . 62n as a function of time. The infrared sensor 60 that generates the output for that determination can be the same infrared sensor 60 that is utilized to determine the temperature of the food item 34 during an automatic heating operation. The rise and fall in the temperature can include a rise from about room temperature to above 30° C. and then back down to about room temperature. As discussed above, a rise and fall in temperature of that magnitude can be assumed to indicate the entry of the hand 72 of the user 38 into the cavity 16 (e.g., to deposit the food item 34) and the subsequent withdrawal of the hand 72 from the cavity 16. Other temperature ranges for the rise and fall of temperature can indicate the entry and withdrawal of the hand 72 into and from the cavity 16.

Estimating the position 50n or positions 50n that the food item 34 occupies as a function of the one or more positions 50a, 50b, . . . 50n where the rise and fall in temperature was recognized to occur can be done in a variety of ways. One example, as described above, is to train an algorithm that correlates the position of food as a function of the hand 72 position and posture within the microwave, and that correlates the hand 72 position and posture within the microwave with temperature as a function of position 50n. Another example is to make an assumption regarding the positions 50a, 50b, . . . 50n of the food item 34 as a function of the rise and fall in temperature. With such an assumption, the position 50n or positions 50a, 50b, . . . 50n that the food item 34 is estimated to occupy can be at least partially different than the one or more positions 50a, 50b, . . . 50n where the rise and fall in temperature was recognized to occur. For example, it can be assumed the food item 34 occupies positions 50a, 50b, . . . 50n directly rearward 73 of positions 50a, 50b, . . . 50n where the rise and fall in temperature was recognized to occur.

At a step 104, the method 100 further includes determining the position 50n or positions 50a, 50b, . . . 50n that the food item 34 is estimated to occupy at the step 102 is suboptimal for the microwave oven 10 to determine accurately, with the infrared sensor 60 of the oven, a temperature of the food item 34 during the automatic heating operation of the food item 34. For example, it can be predetermined that certain of the positions 50a, 50b, . . . 50n within the cavity 16 are not well positioned relative to the infrared sensor 60 for the infrared sensor 60 to produce output from which temperature can be determined with sufficient accuracy.

In embodiments, the method 100 further includes, at a step 106, determining that an object is approaching the cavity 16 of the microwave, before the step 102 of estimating the position 50n or positions 50a, 50b, . . . 50n that the food item 34 occupies. As described above, determining that an object is approaching the cavity 16 can be a cue that the food item 34 may soon be occupying a position 50n or positions 50a, 50b, . . . 50n of the food cavity 16. It may take less processing power to first determine that an object is approaching the cavity 16 before determining the temperature at each position 50n within the cavity 16 than always determining the temperature at each position 50n within the cavity 16. It can be determined that the object is approaching the cavity 16 in a variety of ways, such as a sensor disposed near the opening 30 into the cavity 16. Examples of appropriate sensors include a time of flight sensor 74 or a light curtain 76.

In embodiments, the method 100 further includes, at a step 108, determining that that the door 14 of the microwave oven 10 has moved from the closed position 28 toward the open position 40, before estimating the position 50n or positions 50a, 50b, . . . 50n that the food item 34 occupies. Again, determining that the door 14 has moved from the closed position 28 to the open position 40 can be a cue that the food item 34 may soon be occupying a position 50n or positions 50a, 50b, . . . 50n of the food cavity 16. It may take less processing power to first determine that the door 14 is opening 30 before determining the temperature at each position 50n within the cavity 16 than always determining the temperature at each position 50n within the cavity 16. It can be determined that the door 14 is opening 30 in a variety of ways, such as with a door sensor 82.

In embodiments, the method 100 further includes, at a step 110, issuing the instruction 54 into the external environment 36 calling for the repositioning of the food item 34 within the cavity 16 to occupy a new position 50n or positions 50a, 50b, . . . 50n within the cavity 16. The instruction 54 can be issued visibly via the digital display 56 at the human-machine interface 52, or audibly via the speaker 58, among other ways. The user 38 of the microwave oven 10 thus knows to reposition the food item 34. The user 38 then repositions the food item 34 after receiving the instruction 54.

In embodiments, the method 100 further includes, at a step 112, activating the turntable 46 to reposition the food item 34 to a new position 50n or positions 50a, 50b, . . . 50n within the cavity 16 that is more optimal for the microwave oven 10 to determine accurately, with the infrared sensor 60, the temperature of the food item 34 during the heating operation of the food item 34. Instead or in addition to the step 110 of issuing the instruction 54 and relying on the user 38 to reposition the food item 34, the microwave oven 10 can utilize the turntable 46 to place the food item 34 in a position 50n or positions 50a, 50b, . . . 50n that would allow the output of the infrared sensor 60 to more accurately indicate the temperature of the food item 34.

In embodiments, after the steps 110, 112 resulting in the repositioning the food item 34, the method 100 further includes the step 114 of heating the food item 34. The heating can be the microwave oven 10 automatically heating the food item 34 until the food item 34 reaches a desired temperature. The microwave oven 10 can determine the desired temperature, or the user 38 can inform the microwave oven 10 what is the desired temperature. The microwave oven 10 can determine the temperature of the food item 34 using the output of the infrared sensor 60.

The principles disclosed here have been in the context of the microwave oven 10.

However, the principles can be extended to household appliances generally. For example, monitoring into which region (e.g., shelf) of a refrigerator a hand 72 enters can be utilized to direct cold to that region on the assumption that the hand 72 deposited a heat load (e.g., a recently heated food item 34) at that region.

### EXAMPLES

Example 1—For Example 1, in reference to FIG. 12, a mug full of water at about ambient temperature was placed within the cavity of a microwave oven that was also at about ambient temperature. The output of each of the pixels of the pixel array of the infrared sensor associated with the microwave oven was obtained at a particular point in time. Each pixel corresponds with a different position within the cavity. The temperature at each position within the cavity was calculated as a function of the output of each pixel. The temperatures were then plotted graphically as a function of position with the cavity (or as function of pixel position within the array of pixels). The graph is reproduced at FIG. 12. Because the cavity, the water, and the mug are all at about ambient temperature, the plot does not reveal a temperature contrast or any other signature from which the positions of the water can be determined.

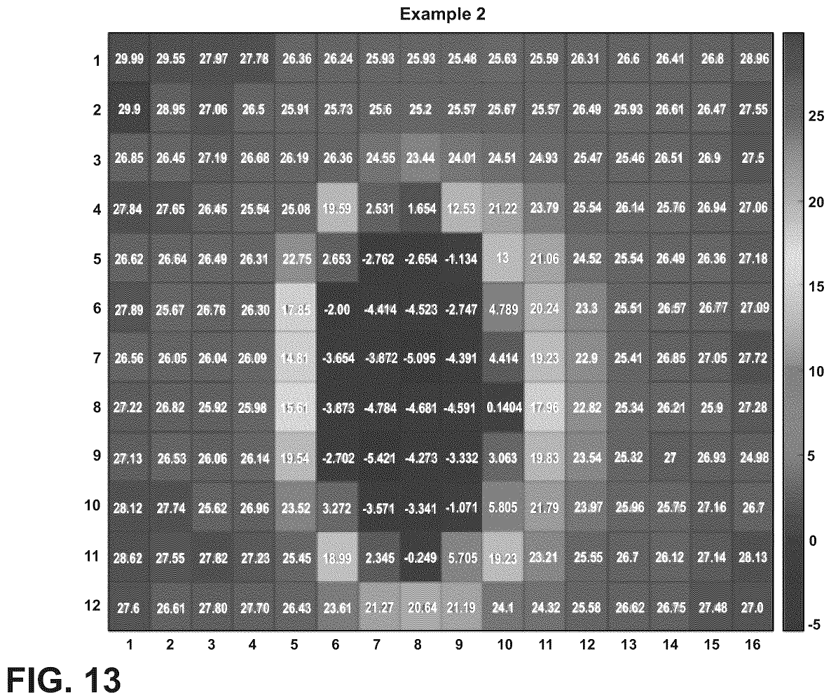

Example 2—For Example 2, in reference to FIG. 13, a frozen beef patty was placed within the cavity of a microwave oven that was at about ambient temperature. The output of each of the pixels of the pixel array of the infrared sensor associated with the microwave oven was obtained at a particular point in time. Each pixel corresponds with a different position within the cavity. The temperature at each position within the cavity was calculated as a function of the output of each pixel. The temperatures were then plotted graphically as a function of position with the cavity (or as function of pixel position within the array of pixels). The graph is reproduced at FIG. 13. Because the temperature of the beef patty contrasts with the temperature of the remainder of the cavity, the output of the infrared sensor can be readily utilized to determine the positions that the beef patty occupies. As the beef patty is relatively centrally placed within the cavity, the microwave oven could automatically heat the beef patty and adequately monitor the temperature thereof until a predetermined temperature is reached.

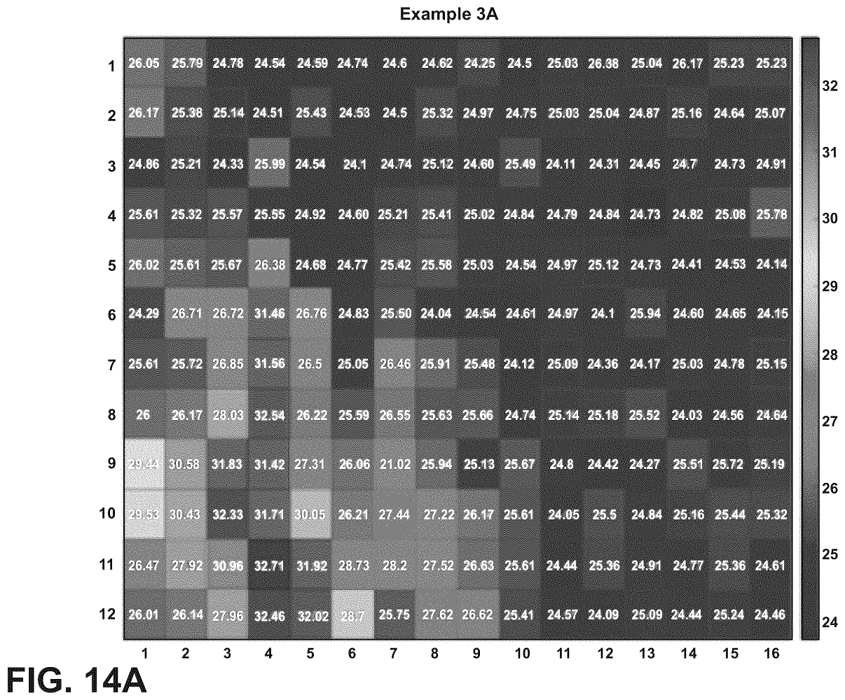

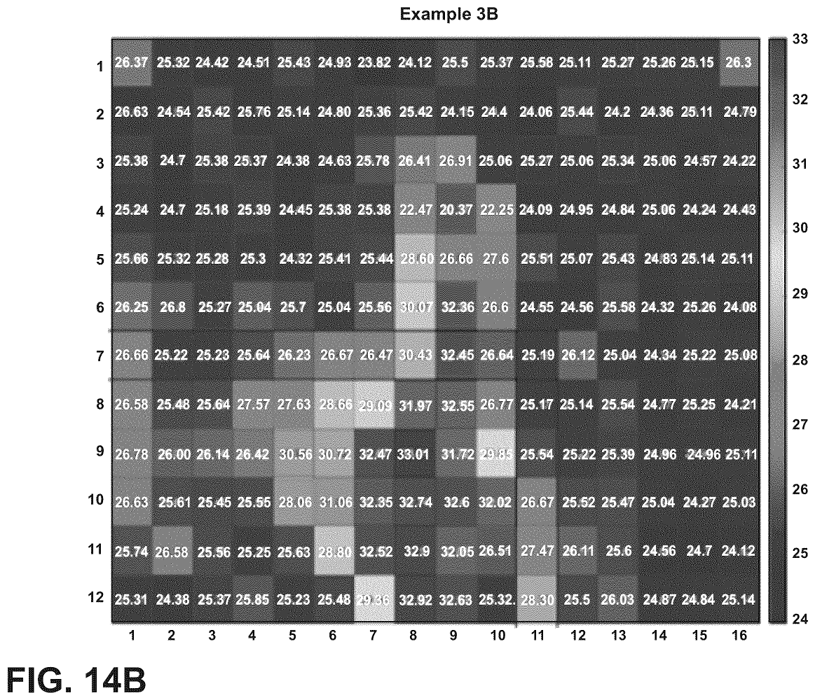

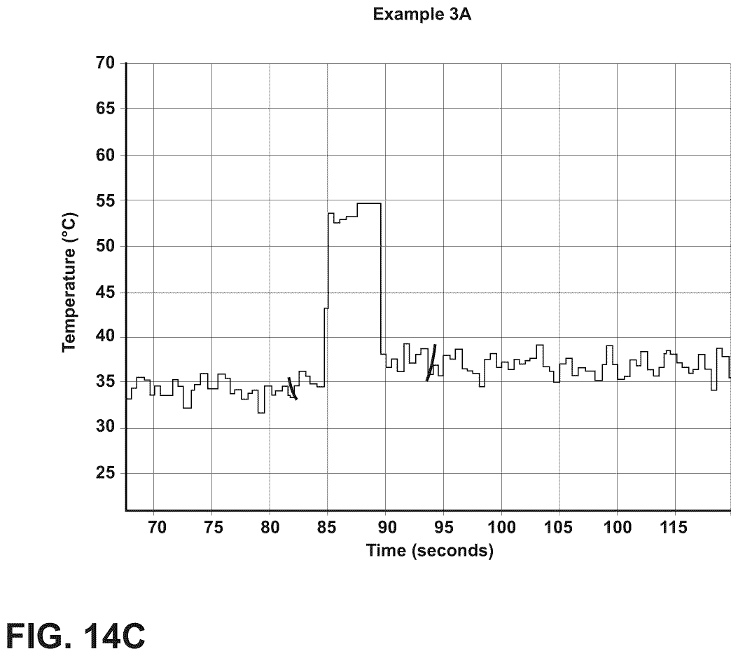

Examples 3A and 3B—For Examples 3A and 3B, in reference to FIGS. 14A-14C, a hand entered with a mug of room temperature water, deposited the mug, and exited the cavity of the microwave. For Example 3A, the hand entered and exited toward the left sidewall of the cavity. For Example 3B, the hand entered and exited more toward the midline of the cavity (e.g., approximately equidistant from each sidewall). The output of each of the pixels of the pixel array of the infrared sensor associated with the microwave oven was obtained at a particular point in time for each of the examples. Each pixel corresponds with a different position within the cavity. The temperature at each position within the cavity was calculated as a function of the output of each pixel. The temperatures were then plotted graphically as a function of position within the cavity (or as function of pixel position within the array of pixels). The graphs for each example is reproduced at FIG. 14A (for Example 3A) and FIG. 14B (for Example 3B). Because the temperature of the hand contrasts with the temperature of the remainder of the cavity, the output of the infrared sensor can be readily utilized to determine the positions that the hand occupies at the particular point in time. The water and mug, being at room temperature like the cavity, were not identifiable with the infrared sensor.

In addition, the maximum temperature calculated from the output of the pixels of the infrared sensor was ascertained as a function of time covering before the hand entered the cavity, while the hand was in the cavity, and after the hand exited the cavity. The maximum temperature as a function of time was graphed. The graph is reproduced at FIG. 14C. As the graph reveals, the entry and exit of the hand into the cavity causes a rise and fall of the maximum temperature within the cavity as a function of time. The temperatures derived from the individual pixels corresponding to the positions within the cavity at which the hand resided would also reveal a rise and fall in temperature.

According to a first aspect of the present disclosure, a microwave oven comprises: (a) a cavity configured to accept a food item for heating, the cavity providing an array of positions at which the food item can be placed; (b) an infrared sensor comprising an array of pixels, each pixel configured to generate an output and each pixel corresponding to a different position of the array of positions of the cavity; (c) a human-machine interface configured to provide an instruction to the user; and (d) a controller in communication with the infrared sensor and the human-machine interface, the controller configured: (i) to determine a temperature at each position of the array of positions of the cavity as a function of the output of each pixel of the array of pixels; (ii) to recognize a rise and fall in the temperature at one or more positions of the array of positions within the cavity; (iii) to estimate the position or positions of the array of positions within the cavity that a food item occupies as a function of the one or more positions of the array of positions within the cavity where the controller recognized a rise and fall in temperature occurred; and (iv) to determine whether the position or positions that the food item is estimated to occupy is adequate for the controller to determine accurately a temperature of the food item during an automatic heating operation that utilizes the infrared sensor.

According to a second aspect of the present disclosure, the microwave oven of the first aspect further comprises a magnetron in communication with the controller, wherein, the controller is further configured to perform (i)-(iv) without first activating the magnetron to increase the temperature of the food item.

According to a third aspect of the present disclosure, the microwave oven of any one of the first through second aspects is presented, wherein the controller is further configured to cause the human-machine interface to issue an instruction to the user to reposition the food item within the cavity to occupy a position or positions that is adequate for the controller to determine accurately the temperature of the food item during the automatic heating operation that utilizes the infrared sensor.

According to a fourth aspect of the present disclosure, the microwave oven of any one of the first through third aspects further comprises: (i) a turntable within the cavity; and (ii) a motor coupled to turntable, the motor in communication with the controller, wherein, the controller is further configured to cause the motor to rotate the turntable to reposition the food item within the cavity to occupy a position or positions that is adequate for the controller to determine accurately the temperature of the food item during the automatic heating operation that utilizes the infrared sensor.

According to a fifth aspect of the present disclosure, the microwave oven of any one of the first through fourth aspects is presented, wherein the rise and fall in the temperature at the one or more positions that the controller is configured to recognize comprise rising from about room temperature to above 30° C. and then back down to about room temperature.

According to a sixth aspect of the present disclosure, the microwave oven of any one of the first through fifth aspects is presented, wherein (i) the controller further comprises a memory and a trained algorithm stored within the memory; and (ii) the controller is configured to utilize the trained algorithm to estimate the position or positions that the food item occupies.

According to a seventh aspect of the present disclosure, the microwave oven of any one of the first through sixth aspects is presented, wherein the controller is configured so that the position or positions that the controller estimates the food item occupies is different or are different than the one or more positions where the rise and fall in temperatures was recognized to occur.

According to an eighth aspect of the present disclosure, the microwave oven of any one of the first through seventh aspects is presented, wherein the infrared sensor comprises a field of view that encompasses at least a perimeter of a floor of the cavity.

According to a ninth aspect of the present disclosure, the microwave oven of any one of the first through sixth aspects is presented, wherein the controller is configured so that the position or positions that the controller estimates the food item occupies either is coextensive with, subsumed by, or is directly rearward of the one or more positions where the controller recognized the rise and fall in temperature occurred.

According to a tenth aspect of present disclosure, the microwave oven of any one of the first through ninth aspects further comprises a time of flight sensor in communication with the controller, the time of flight sensor positioned to generate output from which it can be determined whether an object is approaching the cavity of the microwave oven, wherein, the controller is further configured to determine, as a function of the output generated by the time of flight sensor, that an object is approaching the cavity of the microwave before determining the temperature at each position of the array of positions of the cavity as a function of the output of each pixel of the array of pixels.

According to an eleventh aspect of the present disclosure, the microwave oven of any one of the first through ninth aspects further comprises a light curtain in communication with the controller, the light curtain positioned to generate output from which it can be determined whether an object has crossed an opening into the cavity, wherein, the controller is further configured to determine, as a function of the output generated by the light curtain, that an object has crossed the opening into the cavity before determining the temperature at each position of the array of positions of the cavity as a function of the output of each pixel of the array of pixels.

According to a twelfth aspect of the present disclosure, the microwave oven of any one of the first through eleventh aspects further comprises: (a) a door comprising (i) a closed position denying a user access to the cavity from an external environment and (ii) an open position allowing the user access to the cavity from the external environment; and (b) a door sensor in communication with the controller, the door sensor configured to generate output that changes as a function of whether the door is in the closed position or the open position, wherein, the controller is further configured to determine, as a function of the output generated by the door sensor, that the door has moved away from the closed position toward the open position before determining the temperature at each position of the array of positions of the cavity as a function of the output of each pixel of the array of pixels.

According to a thirteenth aspect of the present disclosure, a microwave oven comprises (a) a cabinet comprising a floor, a ceiling, and opposing sidewalls defining a cavity configured to accept a food item for heating and an opening into the cavity from an external environment; (b) one or more sensors positioned to generate output indicative of whether and where laterally an object enters the opening from the external environment into the cavity; (c) a human-machine interface configured to provide an instruction to the user; (d) an infrared sensor configured to determine a temperature of the food item during an automatic heating operation of the food item; and (e) a controller in communication with the one or more sensors and the human-machine interface, the controller configured: (i) to estimate a position or positions within the cavity that a food item occupies as a function of the output of the one or more sensors; and (ii) to determine whether the position or positions that the food item is estimated to occupy is adequate for the controller to determine accurately the temperature of the food item during the automatic heating operation.

According to a fourteenth aspect of the present disclosure, the microwave oven of the thirteenth aspect is presented, wherein (i) the one or more sensors comprises at least three sensors, each of the at least three sensors having a field of view that is different than the field of view of the other sensors of the at least three sensors; and (ii) the controller is further configured to estimate the position or positions of the food item within the cavity as a function of which of the at least three sensors generated output indicative of the object entering the opening into the cavity from the external environment.

According to a fifteenth aspect of the present disclosure, the microwave oven of the fourteenth aspect is presented, wherein the at least three sensors are time of flight sensors.

According to a sixteenth aspect of the present disclosure, the microwave oven of the fourteenth aspect is presented, wherein the at least three sensors are one-pixel infrared sensors.

According to a seventeenth aspect of the present disclosure, the microwave oven of the fourteenth aspect is presented, wherein the at least three sensors are components of a light curtain.

According to an eighteenth aspect of the present disclosure, the microwave oven of any one of the thirteenth through seventeenth aspects is presented, wherein the controller is further configured (iii) to cause the human-machine interface to issue an instruction to the user to reposition the food item within the cavity to occupy a position or positions that is adequate for the controller to determine accurately the temperature of the food item during the automatic heating operation.

According to a nineteenth aspect of the present disclosure, a method of operating a microwave oven comprises: (a) estimating one or more positions within a cavity of a microwave oven that a food item occupies, without first heating the food item within the cavity; and (b) determining that the one or more positions that the food item is estimated to occupy is suboptimal for the microwave oven to determine accurately, with an infrared sensor of the microwave oven, a temperature of the food item during an automatic heating operation of the food item.

According to a twentieth aspect of the present disclosure, the method of the nineteenth aspect further comprises determining that an object is approaching the cavity of the microwave, before estimating the position or positions that the food item occupies.

According to a twenty-first aspect of the present disclosure, the method of any one of the nineteenth through twentieth aspects further comprises determining that a door of the microwave oven has moved from a closed position denying access to the cavity from the external environment toward an open position allowing access to the cavity from the external environment, before estimating the one or more positions that the food item occupies.

According to a twenty-second aspect of the present disclosure, the method of any one of nineteenth through twenty-first aspects further comprises: (i) issuing an instruction into the external environment calling for the repositioning of the food item within the cavity to occupy a new position or positions within the cavity; and (ii) after the food item is repositioned, heating the food item.

According to a twenty-third aspect of the present disclosure, the method of any one of the nineteenth through twenty-first aspects further comprises: (i) activating a turntable to reposition the food item to a new position or positions within the cavity that is more optimal for the microwave oven to determine accurately, with the infrared sensor, the temperature of the food item during the heating operation of the food item; and (ii) after the food item is repositioned, heating the food item.

According to a twenty-fourth aspect of the present disclosure, the method of any one of the nineteenth through twenty-third aspects is presented, wherein estimating the one or more positions within the cavity that the food item occupies comprises (i) determining a temperature at one or more positions within the cavity, (ii) recognizing a rise and fall in the temperature at the one or more of the positions within the cavity, and (iii) estimating the one or more positions within the cavity that the food item occupies as a function of the one or more positions where the rise and fall in temperature was recognized to occur.

According to a twenty-fifth aspect of the present disclosure, the method of the twenty-fourth aspect is presented, wherein the rise and fall in the temperature at the one or more positions includes a rise from about room temperature to above 30° C. and then back down to about room temperature.

According to a twenty-sixth aspect of the present disclosure, the method of any one of the twenty-fourth through twenty-fifth aspects is presented, wherein the one or more positions within the cavity that the food item is estimated to occupy is at least partially different than the one or more positions of the cavity where the rise and fall in temperature was recognized to occur.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A microwave oven comprising:
a cavity configured to accept a food item for heating, the cavity providing an array of positions at which the food item can be placed;
an infrared sensor comprising an array of pixels, each pixel configured to generate an output and each pixel corresponding to a different position of the array of positions of the cavity;
a human-machine interface configured to provide an instruction to the user; and
a controller in communication with the infrared sensor and the human-machine interface, the controller configured:
(i) to determine a temperature at each position of the array of positions of the cavity as a function of the output of each pixel of the array of pixels;
(ii) to recognize a rise and fall in the temperature at one or more positions of the array of positions within the cavity;
(iii) to estimate the position or positions of the array of positions within the cavity that a food item occupies as a function of the one or more positions of the array of positions within the cavity where the controller recognized a rise and fall in temperature occurred; and
(iv) to determine whether the position or positions that the food item is estimated to occupy is adequate for the controller to determine accurately a temperature of the food item during an automatic heating operation that utilizes the infrared sensor.

2. The microwave oven of claim 1 further comprising:
a magnetron in communication with the controller,
wherein, the controller is further configured to perform (i)-(iv) without first activating the magnetron to increase the temperature of the food item.

3. The microwave oven of claim 1, wherein
the controller is further configured to cause the human-machine interface to issue an instruction to the user to reposition the food item within the cavity to occupy a position or positions that is adequate for the controller to determine accurately the temperature of the food item during the automatic heating operation that utilizes the infrared sensor.

4. The microwave oven of claim 1 further comprising:
a turntable within the cavity; and
a motor coupled to turntable, the motor in communication with the controller,
wherein, the controller is further configured to cause the motor to rotate the turntable to reposition the food item within the cavity to occupy a position or positions that is adequate for the controller to determine accurately the temperature of the food item during the automatic heating operation that utilizes the infrared sensor.

5. The microwave oven of claim 1, wherein
the rise and fall in the temperature at the one or more positions that the controller is configured to recognize comprises rising from about room temperature to above 30° C. and then back down to about room temperature.

6. The microwave oven of claim 1, wherein
the controller further comprises a memory and a trained algorithm stored within the memory; and
the controller is configured to utilize the trained algorithm to estimate the position or positions that the food item occupies.

7. The microwave oven of claim 1, wherein
the controller is configured so that the position or positions that the controller estimates the food item occupies is different or are different than the one or more positions where the rise and fall in temperatures was recognized to occur.

8. The microwave oven of claim 1, wherein
the infrared sensor comprises a field of view that encompasses at least a perimeter of a floor of the cavity.

9. The microwave oven of claim 1, wherein
the controller is configured so that the position or positions that the controller estimates the food item occupies either is coextensive with, subsumed by, or is directly rearward of the one or more positions where the controller recognized the rise and fall in temperature occurred.

10. The microwave oven claim 1 further comprising:
a time of flight sensor in communication with the controller, the time of flight sensor positioned to generate output from which it can be determined whether an object is approaching the cavity of the microwave oven,
wherein, the controller is further configured to determine, as a function of the output generated by the time of flight sensor, that an object is approaching the cavity of the microwave before determining the temperature at each position of the array of positions of the cavity as a function of the output of each pixel of the array of pixels.

11. The microwave oven of claim 1 further comprising:
a light curtain in communication with the controller, the light curtain positioned to generate output from which it can be determined whether an object has crossed an opening into the cavity,
wherein, the controller is further configured to determine, as a function of the output generated by the light curtain, that an object has crossed the opening into the cavity before determining the temperature at each position of the array of positions of the cavity as a function of the output of each pixel of the array of pixels.

12. The microwave oven of claim 1 further comprising:
a door comprising (i) a closed position denying a user access to the cavity from an external environment and (ii) an open position allowing the user access to the cavity from the external environment; and
a door sensor in communication with the controller, the door sensor configured to generate output that changes as a function of whether the door is in the closed position or the open position,
wherein, the controller is further configured to determine, as a function of the output generated by the door sensor, that the door has moved away from the closed position toward the open position before determining the temperature at each position of the array of positions of the cavity as a function of the output of each pixel of the array of pixels.

13. A microwave oven comprising:
a cabinet comprising a floor, a ceiling, and opposing sidewalls defining a cavity configured to accept a food item for heating and an opening into the cavity from an external environment;
one or more sensors positioned to generate output indicative of whether and where laterally an object enters the opening from the external environment into the cavity;
a human-machine interface configured to provide an instruction to the user;
an infrared sensor configured to determine a temperature of the food item during an automatic heating operation of the food item; and
a controller in communication with the one or more sensors and the human-machine interface, the controller configured:
(i) to estimate a position or positions within the cavity that a food item occupies as a function of the output of the one or more sensors; and
(ii) to determine whether the position or positions that the food item is estimated to occupy is adequate for the controller to determine accurately the temperature of the food item during the automatic heating operation.

14. The microwave oven of claim 13, wherein
the one or more sensors comprises at least three sensors, each of the at least three sensors having a field of view that is different than the field of view of the other sensors of the at least three sensors; and
the controller is further configured to estimate the position or positions of the food item within the cavity as a function of which of the at least three sensors generated output indicative of the object entering the opening into the cavity from the external environment.

15. The microwave oven of claim 14, wherein
the at least three sensors are time of flight sensors.

16. The microwave oven of claim 14, wherein
the at least three sensors are one-pixel infrared sensors.

17. The microwave oven of claim 14, wherein
the at least three sensors are components of a light curtain.

18. The microwave oven of claim 13, wherein
the controller is further configured (iii) to cause the human-machine interface to issue an instruction to the user to reposition the food item within the cavity to occupy a position or positions that is adequate for the controller to determine accurately the temperature of the food item during the automatic heating operation.

19. A method of operating a microwave oven comprising:
estimating one or more positions within a cavity of a microwave oven that a food item occupies, without first heating the food item within the cavity; and
determining that the one or more positions that the food item is estimated to occupy is suboptimal for the microwave oven to determine accurately, with an infrared sensor of the microwave oven, a temperature of the food item during an automatic heating operation of the food item.

20. The method of claim 19, wherein
estimating the one or more positions within the cavity that the food item occupies comprises (i) determining a temperature at one or more positions within the cavity, (ii) recognizing a rise and fall in the temperature at the one or more of the positions within the cavity, and (iii) estimating the one or more positions within the cavity that the food item occupies as a function of the one or more positions where the rise and fall in temperature was recognized to occur; and
the one or more positions within the cavity that the food item is estimated to occupy is at least partially different than the one or more positions of the cavity where the rise and fall in temperature was recognized to occur.
